(19) United States
(12) Patent Application Publication
(10) Pub. No.: US 2020/0000193 A1
(43) Pub. Date: Jan. 2, 2020

(54) SMART LUGGAGE SYSTEM

(71) Applicant: LINGDONG TECHNOLOGY(BEIJING)CO.LTD, Beijing (CN)

(72) Inventors: OU QI, Beijing (CN); Fangning CHENG, Beijing (CN); Xinyi TANG, Beijing (CN); GUORONG REN, Beijing (CN)

(21) Appl. No.: 16/565,486

(22) Filed: Sep. 10, 2019

Related U.S. Application Data
(63) Continuation of application No. PCT/CN2018/075836, filed on Feb. 8, 2018.

(30) Foreign Application Priority Data
Jun. 12, 2017 (CN) 201710439633.6

(51) Int. Cl. A45C 5/14; A45C 5/03; A45C 13/26; B62B 5/00; B62B 5/06; G05D 1/00; G05D 1/02; G05D 1/12

(52) U.S. Cl. CPC A45C 5/14; A45C 5/03; A45C 13/262; B62B 5/0076; B62B 5/067; G05D 2201/02; G05D 1/0246; G05D 1/0274; G05D 1/12; A45C 2013/267; G05D 1/0016

(57) ABSTRACT

A smart luggage system includes a piece of luggage, a pull rod, at least one sensor, two driving wheels and two driven wheels. The luggage is configured to store items for transport. The pull rod is coupled to the luggage. The at least one sensor is coupled to the luggage and configured to detect a moving object. The two driving wheels and two driven wheels are coupled to the luggage, wherein the two driving wheels are motorized to move the luggage in a given direction. The pull rod and the at least one sensor are disposed on a front surface of the luggage. The two driven wheels are disposed near the front surface of the luggage and the two driving wheels are disposed near a rear surface of the luggage. The at least one sensor is configured to guide the luggage to follow the moving object.

### CROSS REFERENCE TO RELATED APPLICATIONS

This application is a continuation application of PCT/CN2018/075836, filed on Feb. 8, 2018. This application claims the benefit of PCT/CN2018/075836, which was filed on Feb. 8, 2018, and is incorporated herein by reference.

### BACKGROUND OF THE INVENTION

### 1. Field of the Invention

The present invention relates to automotive robots, and more particularly, to a smart luggage system.

### 2. Description of the Prior Art

By economic development, living standard of human is continuously rising, and people go out more often. For example, people usually take luggage during business or daily trips, and the functional requirements to the luggage are higher and higher. For example, for high level users who take flights, they tend to free up their hands in the long-term outgo to increase an efficiency of time consuming and to reduce load bearing.

Related techniques provide a luggage with automatic following and obstacle avoidance functions, which allows the luggage to follow the users automatically until arriving at the destination, to free up both hands of the users to increase the efficiency of time consuming and reduce the load bearing of the users.

The inventors discovered the luggage in the related techniques has at least the following problem: when the user passes crowed environment for queuing for dealing with business, the function of following may be disturbed. It needs prompt observation and maintaining of the user, so a series of problems to the user reduce the efficiency of time consuming.

### SUMMARY OF THE INVENTION

The present invention relates to a smart luggage system capable of planning an autonomous route independent of the to-be-followed target.

According to an embodiment of the present invention, a smart luggage system comprises a piece of luggage, a pull rod, at least one sensor, two driving wheels and two driven wheels. The luggage is configured to store items for transport. The pull rod is coupled to the luggage. The at least one sensor is coupled to the luggage and configured to detect a moving object. The driving wheels and driven wheels are coupled to the luggage, wherein the two driving wheels are motorized to move the luggage in a given direction. The pull rod and the at least one sensor are disposed on a front surface of the luggage. The two driven wheels are disposed near the front surface of the luggage and the two driving wheels are disposed near a rear surface of the luggage. The at least one sensor is configured to guide the luggage to follow the moving object.

According to another embodiment of the present invention, a smart luggage system comprises a piece of luggage, a pull rod, at least one sensor, two driving wheels, two driven wheels and a main controller. The luggage is configured to store items for transport. The pull rod is coupled to the luggage. The at least one sensor is coupled to the luggage and configured to detect an obstacle. The driving wheels and driven wheels are coupled to the luggage, wherein the two driving wheels are motorized to move the luggage in a given direction. The main controller is configured to determine a first route based on a map data, a beginning location, and a destination location. The pull rod and the at least one sensor are disposed on a front surface of the luggage. The two driven wheels are disposed near the front surface of the luggage and the two driving wheels are disposed near a rear surface of the luggage. The main controller is configured to guide the luggage to move along the first route.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram showing a control system of an automotive luggage provided by an embodiment of the present invention;

FIG. 2 is a block diagram showing a control system of another automotive luggage provided by an embodiment of the present invention;

FIG. 3 is a block diagram showing a control system of an another automotive luggage provided by an embodiment of the present invention;

FIG. 4 is a structural installation diagram showing a main controller and a moving controller in the automotive luggage provided by an embodiment of the present invention;

FIG. 5 is a structural installation diagram showing a transceiver in the automotive luggage provided by an embodiment of the present invention;

FIG. 6 is a structural installation diagram showing each component of a control system in the automotive luggage provided by an embodiment of the present invention;

FIG. 7 is a structural installation diagram showing each component of another control system in the automotive luggage provided by an embodiment of the present invention;

FIG. 8 is a structural installation diagram showing a hall sensor and a magnet in a pull rod of the automotive luggage provided by an embodiment of the present invention;

FIG. 9 is a block diagram showing a smart apparatus provided by an embodiment of the present invention;

FIG. 10 is a block diagram showing a smart luggage system provided by an embodiment of the present invention.

### DETAILED DESCRIPTION

To make the purposes, technical means and advantages clear, the technical means will be illustrated clearly and completely with figures of embodiments of the present invention. Apparently, the embodiments illustrated are only a part of the embodiments of the present invention rather than the entire embodiments. Generally, the components of the embodiments of the present invention shown and illustrated in the figures can be disposed and designed in different arrangements. Therefore, the object of the illustration of the embodiments of the present invention provided in the figures is not to restrict the claim of the present invention to be protected but to demonstrate chosen embodiments of the present invention. All other embodiments based on the embodiments of the present invention gained by the people who are skilled at art in the field without creative efforts should belong to the claim of the present invention.

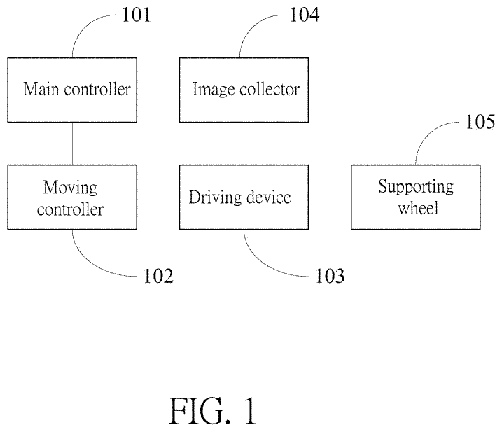

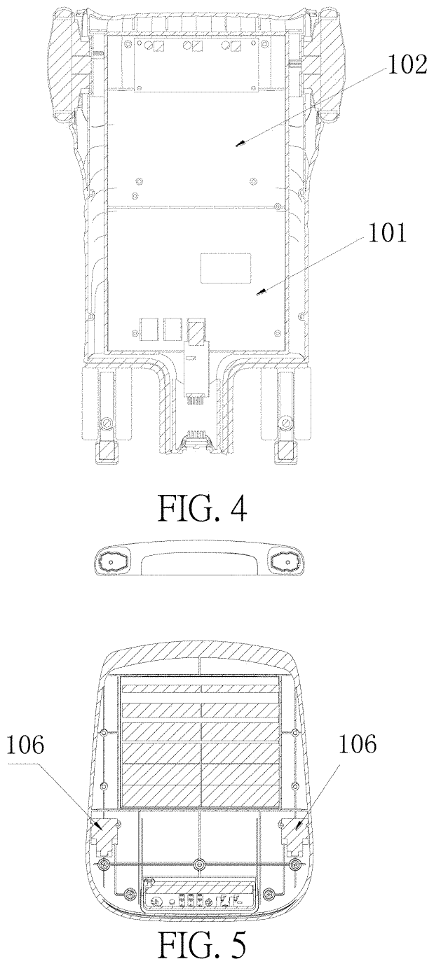

In consideration of the luggage in related techniques being only able to follow a user to arrive at a final goal, when the user goes to a place with complicated road conditions to queue for business, the luggage cannot follow well. Therefore, an instant observation and maintenance by the user to the luggage is needed, which causes a series of problems to the user and reduce the utility of time. Based on the above reasons, an automotive luggage, a smart apparatus and a smart luggage system are provided by the embodiments of the present invention. They will be illustrated by the embodiments with the following FIGS. 1-8.

The embodiment of the present invention provides an automotive luggage 10. Referring to FIGS. 1, 2, 4, 6 and 7, the automotive luggage 10 comprises a luggage main body 100, a main controller 101, a moving controller 102, a driving device 103 respectively located inside the luggage main body 100 and an image collector 104 located outside the luggage main body 100. The moving controller 102 and the image collector 104 are both connected to the main controller 101. A plurality of supporting wheels 105 are disposed on a bottom of the luggage main body 100. The driving device 103 is connected to the moving controller 102 and one or several of the plurality of the supporting wheels 105 and is configured to control the supporting wheel 105 connected thereto to move under control of the moving controller 102.

The image collector 104 is configured to collect road sign information and obstacle image information in the coverage, and transmit the road sign information and obstacle image information to the main controller 101.

The main controller 101 is configured to gain beginning location and destination location of a route, determine first route information according to the beginning location, the destination location, the received road sign information and the received obstacle image information, and transmit the first route information to the moving controller 102.

The moving controller 102 is configured to control the driving device 103 to drive the supporting wheel 105 connected thereto to move along a matched route according to the received first route information.

In the present embodiment, the image collector 104 can be one or several. As a selectable embodiment, the luggage main body 100 is a cuboid, which includes six faces such as front surface, rear surface, two side surfaces connected to the front surface and the rear surface, a top surface and a bottom surface.

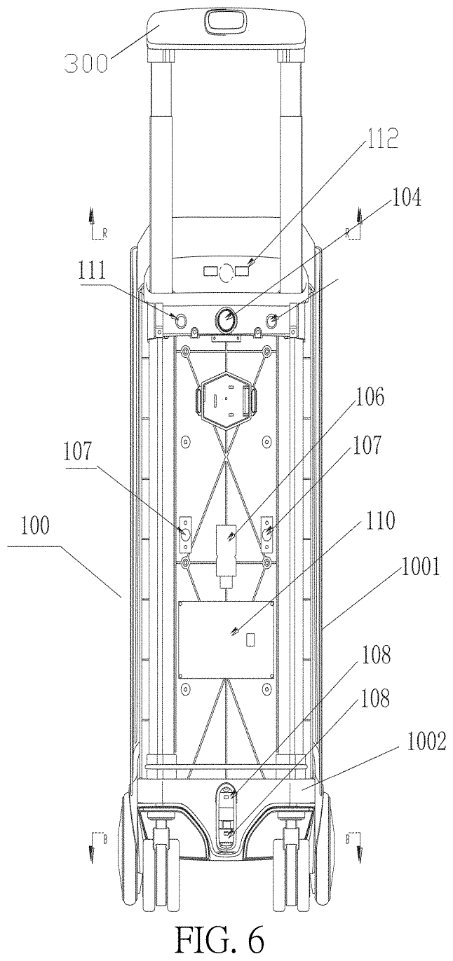

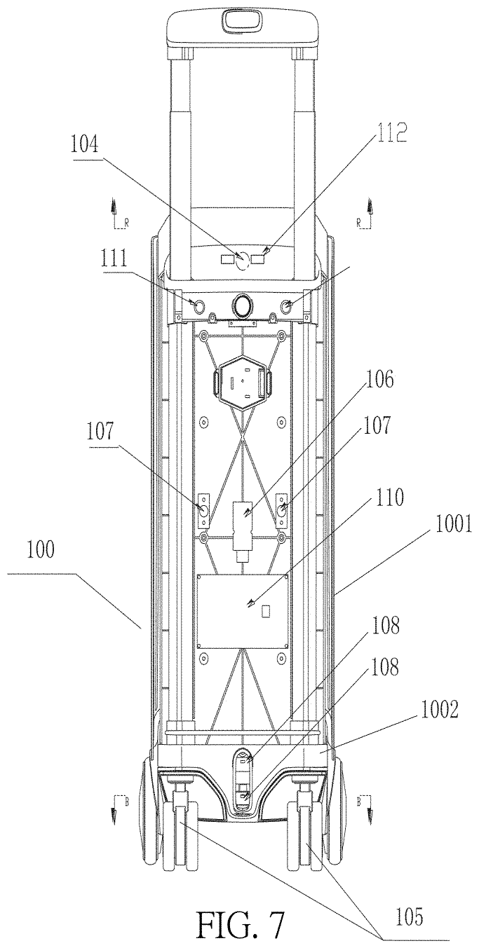

The image collector 104 can be disposed on an upper portion of the front surface of the luggage main body 100, as shown in FIG. 6 specifically, or be disposed between the USB ports (wherein, the two USB ports will be illustrated specifically hereinafter, as shown in FIG. 7). The image collector 104 can be a camera. The camera has a predetermined field of view. Generally, the field of view of a camera is about 140 degrees. When a larger field of view is needed, such as 180 degrees or 360 degrees, a plurality of cameras can be disposed.

The main controller 101 is an industrial personal computer with high performance (i.e. a host). The moving controller 102 is a controller with low power consumption (i.e. a client). The driving device 103 can be motors. As a selectable embodiment, four supporting wheels 105 are disposed on the bottom of the luggage main body 100 and are a left front wheel, a right front wheel, a left rear wheel and a right rear wheel, respectively. The left front wheel, the right front wheel, the left rear wheel and the right rear wheel can use universal wheels. The left rear wheel and the right rear wheel provide motive power for the luggage. The left front wheel and the right front wheel are driven wheels, which for sharing loading pressure from rear wheels driving on the one hand, and make the turn of the luggage more flexible on the other hand. Correspondingly, the motors are two and include a left rear wheel motor and a right rear wheel motor. The left rear wheel motor and the right rear wheel motor are both connected to the moving controller 102 and are electrically connected to the left rear wheel and the right rear wheel, respectively. The two motors drive the two supporting wheels 105 connected thereto to rotate under the control of the moving controller 102. The two supporting wheels 105 act as active wheels (or driving wheels) to drive the other two supporting wheels 105 (or driven wheels) to rotate, so as to drive the luggage main body 100 to move.

The automotive luggage 10 in the present embodiment further comprises a power module 114. The power module 114 is connected to the main controller 101 and the moving controller 102 and is configured to supply power to the motors, the main controller 101 and the moving controller 102. The power module 114 mainly provides DC power and specifically may be a voltage of 2.8 Volts to 3.3 Volts. The power is disposed at the bottom of the luggage main body 100.

Specifically, the moving controller 102 generates a driving command according to the first route information transmitted by the main controller 101 and transmits the driving command to the motors. The motors drive the supporting wheels 105 connected thereto to rotate according to the driving command. Specifically, current is directly proportional to torque of the motors, which reflects on an acceleration. A speed after integration gets a distance value. Since the luggage keeps a constant distance relative to a person, the speed can be calculated. An angle is reflected by a speed difference between the two driving wheels, wherein the speed difference is an angular speed of the luggage. As the luggage moves, angular information can be gained by integration of the angular speed. The moving controller 102 is able to calculate the speed and the angular speed of the luggage according to the distance and the angular speed, further calculate rotation speed of each of the motors, and generates the driving command based on the rotation speed. The moving controller 102 drives the motors to rotate according to the driving command, so as to control operations such as a speed, an angle and a halt of the supporting wheels 105.

Specifically, as a feasible embodiment, the luggage comprises a screen 203. The screen 203 is electrically connected to the main controller 101 and configured to receive the beginning location and the destination location input by the user and transmit the beginning location and the destination location to the main controller 101. The main controller 101 determines the first route information according to the beginning location, the destination location, the road sign information (e.g. a registered indication sign) and the obstacle image information collected by the image collector 104.

To be compared with the luggage which can only follow a user to arrive at a destination without ability to autonomously planning routes in the current technique, the automotive luggage 10 provided by the present embodiment is able to plan a route autonomously and moves according to the route. And finally, the luggage can arrive at the destination without being observed and maintained by the user in a complex environment. Thus, the utilization of time is increased.

Besides, referring to FIGS. 1, 2, and 5-7, the automotive luggage 10 in the present embodiment further comprises a memory 115. The memory 115 pre-stores map data including the beginning location and the destination location. As a selectable embodiment, the automotive luggage 10 is further configured to: 1. gain the map data, the beginning location, and the destination; and 2. determine the first route information according to the beginning location, the destination location, the map data and the obstacle image information; and 3. transmit the first route information to the moving controller 102.

Specifically, the main controller 101 is further configured to gain the map data including the beginning location and the destination location from the memory 115. Or, the main controller 101 communicates with a terminal device (e.g. the user's smartphone), and gains the map data (e.g. an obtained airport map) from the terminal device through the communication.

Then, the main controller 101 determines the first route information according to the beginning location, the destination location, the map data and the obstacle image information, and transmits the first route information to the moving controller 102.

Additionally, referring to FIGS. 1, 5, 6 and 7, the automotive luggage 10 of the present embodiment further comprises a transceiver 106 located inside the luggage main body 100.

The image collector 104 is further configured to collect image information of a to-be-followed target in the field of view and transmit the image information of the to-be-followed target to the main controller 101.

The transceiver 106 is configured to gain the location information of the to-be-followed target and the luggage main body 100, and transmit the location information to the main controller 101.

The main controller 101 is configured to determine second route information according to the received image information and the received location information of the to-be-followed target, and transmit the second route information to the moving controller 102.

The moving controller 102 is further configured to control the driving device 103 to drive the supporting wheels 105 connected thereto to move along the second route according to the received second route information.

Specifically, the to-be-followed target (i.e. the owner of the luggage) is included in the field of view of the camera. The camera obtains the image information of the owner in real time and transmits the image information to the driving device 103. The transceiver 106 can be a UWB transceiver. UWB (Ultra Wideband) wireless communication is a communicating method introducing pulses with extremely short time intervals (less than 1 ns) rather than carriers. It obtains the location information of the to-be-followed target and the luggage main body 100 and transmits the location information to the main controller 101. The location information includes the distance information between the luggage and the to-be-followed target (i.e. the owner) and the angle information between the luggage and the to-be-followed target.

Specifically, the main controller 101 is connected to the transceiver 106, the image collector 104 and the following indication control panel 110 via ports. The main controller 101 is a data fusion module and a central processing module of the luggage main body 100, and is also a control center with high performance of the entire luggage. The main controller 101 is configured to collect information of the location of the owner and the environmental image information during moving, to obtain the orientation information (i.e. the location information) of both the owner and the luggage main body 100 through the transceiver 106 and to provide the moving controller 102 with the orientation information and the controlling strategy command for motor controlling through the communication with the moving controller 102.

After receiving the location information transmitted from the transceiver 106, the main controller 101 executes necessary filter processing to the location information, and obtains the final location information between the luggage and the owner.

The luggage mainly uses a UWB locating method as a wireless locating method, wherein the UWB transceiver is disposed in the luggage main body 100. There are mainly two implementations about the number and the location of the UWB transceiver: (1) Three UWB transceiver modules are adopted, and are disposed in the center inside the luggage main body 100, avoiding near metal objects. Specifically, two UWB transceivers are disposed at a rear portion of the luggage main body 100, a UWB transceiver is disposed in front of the luggage, and the three UWB transceivers are disposed at the same horizontal plane to ensure the UWB transceivers being able to communicate effectively with a UWB locating chip disposed in the smart apparatus 20. (2) A UWB transceiver is disposed inside the luggage main body 100, and determines the angle information and the distance between the luggage main body 100 and the UWB locating chip disposed on the owner according to the communication between the UWB transceiver and the locating chip 201 located in the smart apparatus.

The image collector 104 is arranged outside an upper portion of the luggage main body 100. It can be disposed on the front surface of the luggage main body 100 specifically, as shown in FIG. 6. It can also be disposed between two USB ports (wherein the two USB ports are illustrated specifically hereinafter, as shown in FIG. 7). The image collector 104 is mainly configured to collect the visual environmental information for the luggage, and can be configured to collect the image information of the to-be-followed target (i.e. the owner) and the obstacle image information. The main controller 101 is configured to extract and recognize the image characteristics of the owner, so as to control the moving controller 102 to control the supporting wheels 105 connected thereto to move and then to control the luggage main body 100 to follow the owner. Besides, the main controller 101 is able to determine obstacles in the sight and plan the first route and the second route to control the moving controller 102 to perform obstacle avoidance according to the obstacle image information collected by the camera when controlling the moving controller 102 to follow the to-be-followed target, which guarantees the autonomous moving of the luggage. The visual learning contributed by the camera and the main controller 101 provides an intellectual program for the autonomous moving and the independent route planning of the luggage.

Besides, the main controller 101 is able to recognize the gesture of the owner from the image information of the to-be-followed target (i.e. the owner). When the luggage is in a stand-by state, the main controller 101 detects whether the to-be-followed target (i.e. the owner) exists in the received imaged information captured by the image collector 104. If the to-be-followed target (i.e. the owner) is detected in the received image information and the recognition is successful, then the planning of the second route is executed and the main controller 101 controls the moving controller 102 to follow. The luggage completes initialization and change to a moving state. The camera continually captures the image information and transmits the image information to the main controller 101. Meanwhile, the main controller 101 recognizes gestures of the to-be-followed target (i.e. the owner) in the image information and performs different operations based on different gesture recognition. For example, when a hand pushes from chest is recognized, the luggage changes from a moving state to a pause state autonomously.

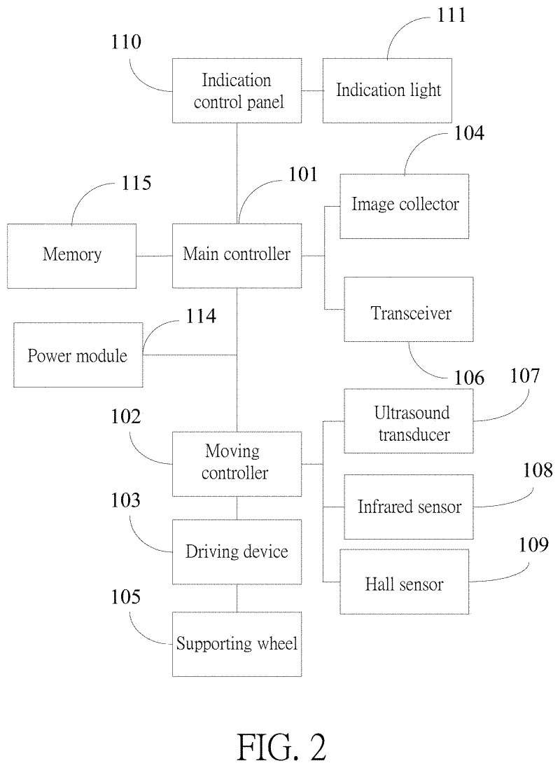

Furthermore, referring to FIGS. 2, 6 and 7, the automotive luggage 10 of the present embodiment further comprises an ultrasound sensor 107 located outside the luggage main body 100. The ultrasound sensor 107 is electrically connected to the moving controller 102.

The ultrasound sensor 107 is configured to detect the obstacle in a first range of the luggage main body 100, and transmit an obtained first obstacle data to the moving controller 102 after handling the detected obstacle.

The moving controller 102 is further configured to receive the first obstacle data and transmit the first obstacle data to the main controller 101.

The main controller 101 is further configured to optimize the first route information or the second route information according to the received first obstacle data, and transmit the optimized first route information or the optimized second route information to the moving controller 102.

Additionally, referring to FIGS. 2, 6 and 7, the automotive luggage 10 of the present embodiment further comprises an infrared sensor 108 located outside the luggage main body 100. The infrared sensor 108 is electrically connected to the moving controller 102.

The infrared sensor 108 is configured to detect the obstacle in a second range of the luggage main body 100, and transmit an obtained second obstacle data to the main controller 101 after handling the detected obstacle.

The moving controller 102 is further configured to receive the second obstacle data and transmit the second obstacle data to the main controller 101.

The main controller 101 is further configured to optimize the first route information or the second route information according to the received second obstacle data, and transmit the optimized first route information or the optimized second route information to the moving controller 102.

Specifically, the ultrasound sensor 107 is mainly configured to collect the distance information (i.e. the first obstacle data) of the obstacle in front of the luggage main body 100. The infrared sensor 108 is mainly configured to detect the obstacle information (i.e. the second obstacle data) in two directions: (1) the distance information of the obstacle in front of the luggage main body 100 and (2) the distance information of the obstacle right oblique below the luggage main body 100 (e.g. the downward obstacle such as stairs or steps).

The ultrasound sensor 107 and the infrared sensor 108 act as obstacle avoidance sensing units. They transmit the obstacle data to the main controller 101 after collecting the obstacle data in front of and right oblique below the luggage main body 100, so as to enable the main controller 101 to plan an obstacle avoiding route and optimize the planned first route or the planned second route.

Specifically, when the main controller 101 plans the route, it executes obstacle avoidance autonomously after receiving the obstacle data detected by the obstacle avoidance sensing units. The main controller 101 compares the first route information or the second route information with the obstacle data and analyzes the comparison results (Specifically, an artificial potential field method can be used to pull rod the obstacle avoidance). Then, the main controller 101 optimizes the first route information or the second route information, and transmits the optimized first route information or the optimized second route information to the moving controller 102.

The moving controller 102 is specifically configured to control the driving device 103 to drive the supporting wheels 105 to move along the optimized first route or the optimized second route according to the received optimized first route information or the received optimized second route information.

Additionally, according to the present embodiment, the moving controller 102 is further configured to generate a braking command to control the driving device 103 according to the received first obstacle data or the received second obstacle data, and transmit the braking command to the driving device 103.

The driving device 103 is further configured to brake and lock according to the braking command.

The obstacle avoidance sensing units such as the ultrasound sensor 107 and the infrared sensor 108 collect the obstacle data. Then the moving controller 102 transmits the obstacle data to the main controller 101. Given that a period of time is needed for the main controller 101 to optimize the route based on the obstacle data, to prevent the luggage main body 100 from bumping into the obstacle during the period of time, the moving controller 102 is able to generate the braking command to control the driving device 103 to brake and lock based on the obstacle data directly. The moving controller 102 controls the driving device 103 to brake according to the braking command directly to prevent the luggage main body 100 from bumping into the obstacle. Meanwhile, it provides a time guarantee for the main controller 101 to reschedule the route.

Furthermore, referring to FIGS. 2 and 8, the automotive luggage 10 of the present embodiment further comprises a pull rod 300 connected to the luggage main body 100, a hall sensor 109 and a magnet 113. The pull rod 300 comprises an outer tube 3001 and an inner tube 3002 stretchably connected to and disposed inside the outer tube 3001. The hall sensor 109 is disposed on the outer tube 3001. The magnet 113 is disposed on the inner tube 3002. When the hall sensor 109 moves close to or away from the magnet 113, the hall sensor 109 has an electric potential variation.

Besides, as shown in FIG. 6, the pull rod 300 is disposed on the same side as the image collector 104. That is, the pull rod 300 is disposed on the front surface of the luggage main body 100.

The moving controller 102 is further configured to gain a current electric potential data of the hall sensor 109, to compare the current electric potential data with a previous electric potential data, and transmit the result of the comparison to the main controller 101.

The main controller 101 is further configured to receive the result of the comparison, ensure the status information of the luggage according to the result, and enable or disable the image collector 104 and/or the transceiver 106 according to the ensured status information of the luggage.

Specifically, when the pull rod 300 is at a collapsed state, the hall sensor 109 is in a low electric potential; when the pull rod 300 is at an extracted state, the hall sensor 109 has an electric potential variation and changes to a high electric potential. The moving controller 102 (i.e. the client) works for detecting the state of the pull rod 300: collapsed or extracted. When the pull rod 300 is extracted, the moving controller 102 transmits the electric potential variation information to the main controller 101, and then the main controller 101 starts to enable the camera vision (CV, i.e. the image collector 104) and the transceiver 106 and then the luggage goes to the stand-by state. When the pull rod 300 is collapsed, the luggage changes to a shut-down state, and the camera vision (CV, i.e. the image collector 104) and the transceiver 106 turn off.

Specifically, as shown in FIG. 6, USB ports 112 are disposed on the top portion of the front surface of the luggage main body 100 (as a selectable embodiment, the number of the USB ports 112 is two). The USB ports 112 are extended outside from the main controller 101, electrically connected to the main controller 101 and configured for the user to charge for his or her electric devices such as a phone or a tablet.

Furthermore, referring to FIGS. 2, 6 and 7, the automotive luggage 10 of the present embodiment further comprises an indication control panel 110 located inside the luggage main body 100 and an indication light 111 located outside the luggage main body 100. The indication light 111 is electrically connected to the indication control panel 110.

The main controller 101 is further configured to generate an indication control command configured to control the indication light 111 according to the first route information, the second route information or the status information, and transmit the indication control command to the indication control panel 110.

The indication control panel 110 is configured to receive the indication control command and switch the indication light 111 to match the indication control command.

Specifically, the indication control panel 110 is further disposed on the luggage main body 100. The indication control panel 110 is connected to the main controller 101 via the ports. The indication control panel 110 is configured to interact with the owner and help the owner to determine the luggage status according to the display on a front panel, so as to operate corresponding commands.

Specifically, the luggage mainly comprises the following states during using: shut-down state, stand-by state, recognition successful state, moving state, pause state. Besides, it further comprises pulling state, alarm state and warning state.

Specifically, the to-be-followed target comprises a smart apparatus 20 (e.g. a smart wristband). The smart apparatus 20 cooperates with the automotive luggage 10. When the luggage is at the moving state, if the user once presses a control button 204 on the smart wristband, the luggage changes to the pulling state. At that time, the indication control panel 110 (i.e. the front panel) turns off all the indication light 111. If the user presses and hold the control button 204 on the smart wristband for three seconds, the luggage changes to the alarm state, and the indication light 111 on the front panel blinks, like sparkles.

When the luggage is in the pulling state, as the pull rod 300 is collapsed, the luggage changes to the shut-down state. When the pull rod 300 is not collapsed and receives a control command from the control button 204 on the owner's wristband, the luggage changes to the stand-by state.

Moreover, referring to FIG. 2, the automotive luggage 10 of the present embodiment further comprises a power module 114. The power module 114 is electrically connected to the main controller 101 and the moving controller 102 and configured to supply electricity for the main controller 101 and the moving controller 102.

Additionally, referring to FIGS. 6 and 7, in the present embodiment, the luggage main body 100 comprises a base 1002 and a box body 1001 disposed on the base 1002.

The main controller 101 is located in the box body 1001 and disposed at an upper position of the box body 1001. The moving controller 102 is located in the box body 1001 and disposed at a lower position of the box body 1001. The transceiver 106 is located in the box body 1001 and disposed at a middle position of the box body 1001.

Furthermore, referring to FIG. 6 and FIG. 7, in the present embodiment, there are a plurality of the ultrasound sensors 107. The plurality of the ultrasound sensors 107 are disposed on a side of the box body 1001 and on the base 1002.

Furthermore, referring to FIGS. 6 and 7, in the present embodiment, there are a plurality of the infrared sensors 108. The plurality of the infrared sensors 108 are disposed on the base 1002.

The obstacle avoidance sensing units mainly comprises three ultrasound sensors 107 and two infrared sensors 108 (i.e. laser transducers). The laser transducers are mainly disposed right below the box body 1001. Two of the ultrasound sensors 107 are disposed on the middle of the front, and a ultrasound sensor 107, which is configured to detect whether there is any obstacle during moving and generate obstacle data when detecting there is an obstacle, is disposed on the rear of the box body 1001. The moving controller 102 gains the obstacle data of the obstacle sensing module directly and controls the luggage to avoid the obstacle according to the obstacle data.

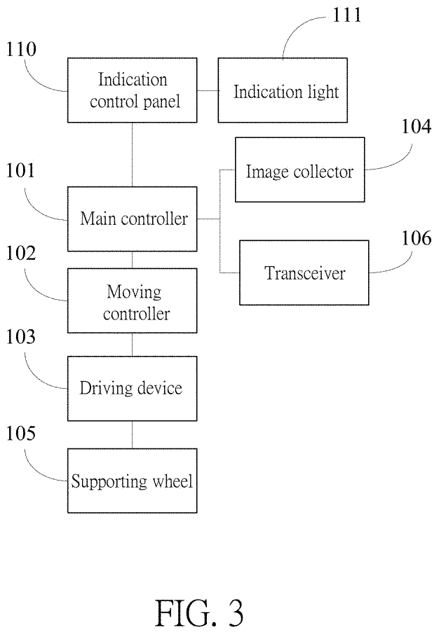

The embodiment of the present invention further provides an automotive luggage 10. Referring to FIG. 3, the automotive luggage 10 comprises a luggage main body 100, a main controller 101, a transceiver 106, a moving controller 102, a driving device 103 respectively located inside the luggage main body 100, and an image collector 104 located outside the luggage main body 100. The moving controller 102, the transceiver 106 and the image collector 104 are connected to the main controller 101. A plurality of supporting wheels 105 are disposed on the bottom of the luggage main body 100. The driving device 103 is connected to the moving controller 102 and one or several of the plurality of supporting wheels 105 and is configured to control the supporting wheel 105 connected thereto to move under the control of the moving controller 102.

The image collector 104 is configured to collect road sign information and obstacle image information in a field of view and transmit the road sign information and the obstacle image information to the main controller 101.

The transceiver 106 is configured to gain location information of a to-be-followed target and the luggage main body 100 and transmit the location information to the main controller 101.

The main controller 101 is configured to determine a third route information according to the received road sign information, the received location information and the second obstacle data and transmit the third route information to the moving controller 102.

The moving controller 102 is configured to control the driving device 103 to drive the supporting wheel 105 connected thereto to move along the matched route according to the received third route information.

Specifically, the third route is the same as the second route. The automotive luggage 10 provided by the corresponding embodiment of the present invention can further comprise an ultrasound sensor 107 located outside the luggage main body 100, an infrared sensor 108 located outside the luggage main body 100, a pull rod 300 connected to the luggage main body 100, a hall sensor 109, a magnet 113, an indication control panel 110 located inside the luggage main body 100 and an indication light 111 located outside the luggage main body 100. The specific technical characteristics are the same as the previous embodiment, so they are omitted here.

The automotive luggage 10 provided by the present embodiment is able to follow the target based on the visual collector with high precision, so the time efficiency is increased.

The embodiment of the present invention further provides a smart apparatus 20. Referring to FIG. 9, the smart apparatus 20 is taken with the to-be-followed target and configured to locate the automotive luggage 10 in the above embodiments and the to-be-followed target. The smart apparatus 20 comprises a positioning chip 201. The positioning chip 201 is communicationally connected to the transceiver 106.

The positioning chip 201 is configured to transmit a first timestamp data to the transceiver 106.

The transceiver 106 is configured to receive the first timestamp data from the positioning chip 201 and transmit a second timestamp data to the positioning chip 201 after receiving the first timestamp data.

The positioning chip 201 is further configured to receive the second timestamp data, generate the location information according to the first timestamp data, the second timestamp data and a preset transmitting speed of a timestamp data, and transmit the location information to the transceiver 106.

The transceiver 106 is further configured to receive the location information and transmit the location information to the main controller 101.

As a selectable embodiment, the positioning chip 201 is a UWB positioning chip located in the smart apparatus 20 (e.g. a smart wristband). The transceiver 106 is located in the luggage main body 100 of the automotive luggage 10, wherein n UWB transceivers (n>=1) execute communication and data capturing. The UWB positioning chip communicates with the n UWB transceivers. The UWB positioning chip records timestamp of the communication between the UWB positioning chip and the UWB transceivers (the timestamp is transmitted in a form of data packet). Distance information between the UWB positioning chip and the UWB transceivers is calculated according to communication time corresponding to the timestamp and transmission rate information of the data packet. Then the UWB positioning chip encloses all detected distance information relative to the UWB transceivers into packets, and transmits the enclosed packets to one of the UWB wireless transceiving module (the UWB module is connected to the main controller 101 via ports) through wireless communication. The UWB module finally transmits the gained distance between the luggage and the UWB positioning chip (wristband) to the main controller 101.

The main controller 101 executes filter processing to all distance information between the UWB positioning chip and the UWB transceivers to gain the final location information between the luggage and the owner.

The UWB positioning chip is located in the wristband worn by the owner. The UWB transceivers are mainly disposed at a middle position of the luggage main body 100 and configured to execute UWB wireless radio frequency positioning to detect the angle information and the distance between the luggage main body 100 and the owner, so as to provide coordinate information relative to the owner for the main controller 101.

Furthermore, referring to FIG. 9, the smart apparatus 20 provided by the embodiment of the present invention further comprises a vibration member 202. The vibration member 202 is electrically connected to the positioning chip 201.

The positioning chip 201 is further configured to gain status information of the smart apparatus 20, to generate a first control command according to the status information of the smart apparatus 20, and to transmit the first control command to the vibration member 202.

The vibration member 202 is configured to receive the first control command, activate a vibration matching the first control command to indicate the status information of the smart apparatus 20.

Additionally, referring to FIG. 9, the smart apparatus 20 provided by the present embodiment further comprises a screen 203. The screen 203 is electrically connected to the positioning chip 201.

The positioning chip 201 is further configured to gain status information of the smart apparatus 20, generate a second control command according to the status information of the smart apparatus 20, and transmit the second control command to the screen 203.

The screen 203 is configured to receive the second control command and display the status information of the smart apparatus 20 matching the second control command according to the second control command.

Additionally, referring to FIG. 9, the smart apparatus 20 provided by the present embodiment further comprises a control button 204. The control button 204 is electrically connected to the positioning chip 201.

The control button 204 is configured to receive a touching operation of a user and transmit a command data matching the touching operation to the positioning chip 201 so that the positioning chip 201 responds with the command data.

Furthermore, the smart apparatus 20 of the present embodiment further comprises a smart apparatus main body wherein the positioning chip 201 and the vibration member 202 are both disposed inside the smart apparatus main body. The control button 204 is disposed outside the smart apparatus main body.

Specifically, the luggage cooperates with a corresponding smart apparatus 20 (e.g. a wristband). A UWB positioning module is disposed inside the wristband wherein the wristband has the control button 204 and is configured to communicate with the box body 1001 of the luggage. The screen 203, a LED module and the vibration member 202 are disposed in the wristband. The LED module and the vibration member 202 are mainly disposed to indicate the current status of the luggage, and can remind the user by the LED module or the vibration frequency. Especially, when some criteria happen like the luggage is going to lose the owner or exceeds a safety range, they can remind the owner and provide the specific location information of the luggage to the owner.

The smart apparatus 20 can comprise the screen 203 or does not comprise the screen 203. The UWB positioning chip is mainly configured to communicate with the UWB transceivers located in the luggage main body 100 to provide the location information of the luggage to the user.

The smart apparatus 20 provided by the present embodiment is configured to cooperate with the automotive luggage 10 to make the luggage able to plan a route autonomously, move along the route, and finally arrive at the destination by itself. Users do not need to observe and maintain the luggage in a complex environment. A series of problems to the users are avoided, and time efficiency is thus increased. Or, it can cooperate with the automotive luggage 10, drive the automotive luggage 10 to follow the target using the visual collector with high precision, so the time efficiency is increased.

The embodiment of the present invention further provides a smart luggage system. Referring to FIG. 10, the smart luggage system comprises the automotive luggage 10 and the smart apparatus 20.

Hereby, the automotive luggage 10 provided by the embodiment of the present invention will be illustrated.

The moving controller 102 (i.e. the control unit of the client) is mainly disposed under the bottom of the luggage main body 100 and is configured to communicate with the motors, the obstacle avoidance sensing unit (e.g. the ultrasound sensor 107 and the infrared sensor 108) and the hall sensor 109 disposed on the pull rod 300 and then capturing the data. The moving controller 102 mainly supplies power through the power module 114 (i.e. a direct power module). The moving controller 102 is configured to control the moving state such as speed or angle to drive the two rear wheels of the luggage main body 100 to move. Besides, the moving controller 102 can capture obstacle data through the communication with the obstacle avoidance sensing unit such as the ultrasound sensor 107 and the laser transducer, so as to the main controller 101 can control the luggage to avoid the obstacle, optimize the route and control the motors to brake under emergency pull rod when the luggage is moving. The moving controller 102 can continually check the status of the hall sensor 109 on the pull rod 300 of the luggage in order the main controller 101 determine the corresponding status of the luggage via the gained status of the pull rod 300.

The main controller 101 is mainly disposed on the bottom of the luggage and is charged by the power module 114. The main controller 101 is communicationally connected to the front panel, the UWB positioning module, the camera and the moving controller 102 via the ports. In the luggage, the main controller 101 acts as the task processing center of the luggage and is mainly configured to gain the orientation information and the visual information of the user. Besides, the main controller 101 gives commands to the moving controller 102 and displays the status information of the luggage via the front panel to the user to ensure the luggage works normally. The main controller 101 is responsible for gaining the information of the radio positioning, gains the distance and the orientation information between the target user and the luggage via the wireless communication with the UWB positioning module, obtains and recognizes the visual image information and gestures via the connection with the camera, and collects and determines image information of the user and the environment. The host display status information of the luggage via the front panel to help the user to determine the status of the luggage according to the front panel information. Besides, the main controller 101 can get the status of the pull rod 300 via the communication with the moving controller 102, so as to determine the status of the luggage. Meanwhile, the main controller 101 is able to transmit the corresponding commands to the moving controller 102 according to the received radio orientation information and visual information to control the status of the driving wheels of the luggage.

The positioning module can employ combination of several positioning modules such as the visual positioning module, the UWB positioning module, the ultrasound positioning module, the infrared positioning module. The positioning module is to ensure the location information of the luggage owner relative to the luggage such as the orientation, the distance, the angle, the height, the profile and other external characteristics, wherein the visual positioning module mainly comprises a visual transducer and a visual data processing module. The UWB positioning module, the ultrasound positioning module, and the infrared positioning module are all able to be detachable.

The luggage further equips with a UWB wristband. The UWB wristband is mainly configured to be worn on the wrist when the owner uses the luggage. A UWB positioning chip, a control button, a vibration motor and a LED light are disposed on the UWB wristband, wherein the UWB positioning chip is mainly configured to execute wireless communication with the UWB module disposed in the luggage to gain the orientation information between the owner and the luggage. The control button can be configured to transmit commands to the luggage: (1) press the button once to switch the luggage to the pulling state; (2) press three times to switch the luggage to the alarm state; (3) press twice to switch the luggage from the pause state to the stand-by state. The vibration motor module indicates different status of the luggage to the user via different vibration states, such as a strong vibration state or a long-term vibration state. The LED light reminds the user by different flashing states. For example, the LED light flashes normally indicate the luggage is moving normally and the LED light sparkles strongly indicate the luggage is in the alarm state.

Preferably, the vibration motor of the UWB wristband and the flash of the LED light can cooperate to display a monitoring state of the UWB and the camera vision: (1) UWB regular, CV regular: vibrates slowly with white light flashes; (2) UWB regular, CV weak: vibrates strongly with red light flashes strongly; (3) UWB weak, CV regular: vibrates slowly with white light flashes; (4) UWB weak, CV weak: vibrates strongly with red light flashes. Meanwhile, when the luggage is in the warning state, the UWB wristband will be in the long-term vibration state and the LED light will keep in red with flashing.

The method of moving autonomously for the automotive luggage 10 of the present invention is described as following:

1. When the owner wants to use the luggage, the image collector 104 will begin to collect the image. The main controller 101 will begin to recognize to clarify the owner of the luggage to help the owner to operate the luggage in future.

2. Relative coordinate information is established according to the received data by the main controller 101 from such as the image collector 104, the transceiver 106, the ultrasound sensor 107 and the infrared sensor 108.

3. The luggage plans an autonomously moving route based on the beginning location and the destination location input by the user, determines road signs and selects moving proposal autonomously based on the information gained by the visual module (i.e. the image collector 104), sets up the best moving strategy and avoids obstacle by the help of the data information integrated by the obstacle avoidance sensing units.

4. When luggage autonomously moves, the luggage continually determines according to its own position and the orientation information from the owner. If exceeding the safety range, the luggage will alarm. The luggage waits for the command of the owner for next action after arriving at the destination.

5. When following the owner, the luggage can follow behind the owner after recognizing the owner. The luggage is able to recognize the walking gait, the walking speed, the walking direction and the walking route of the owner, predict according to these information and optimize the following route to keep a constant distance from the owner.

Besides, in the embodiments provided by present invention, the each functional unit can be integrated into one processing unit, or exists alone, or two or more than two units centralize in a unit.

When the functions are realized in a software manner and sold or used as independent goods, they can be stored in a computer readable medium. Based on it, the contribution or the technical method in the present invention can be realized in software. If the software is stored in a memorizing medium, all or partial of the procedures of the method in the present invention can be executed by a computer (e.g. a personal computer, a server, or an internet device) according to several commands. The memorizing medium comprises a USB disk, a portable hard disk, a read-only memory (ROM), a random access memory (RAM) or a disc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A smart luggage system, comprising:
a piece of luggage configured to store items for transport;
a pull rod coupled to the luggage;
at least one sensor coupled to the luggage and configured to detect a moving object; and
two driving wheels and two driven wheels coupled to the luggage, wherein the two driving wheels are motorized to move the luggage in a given direction;
wherein the pull rod and the at least one sensor are disposed on a front surface of the luggage;
wherein the two driven wheels are disposed near the front surface of the luggage and the two driving wheels are disposed near a rear surface of the luggage;
wherein the at least one sensor is configured to guide the luggage to follow the moving object.

2. The smart luggage system of claim 1, further comprising a USB port disposed on a top portion of the front surface of the luggage.

3. The smart luggage system of claim 1, wherein the at least one sensor is selected from at least one camera, infrared sensor or ultrasonic sensor.

4. The smart luggage system of claim 1, further determining a route based on a map data, a beginning location, and a destination location.

5. The smart luggage system of claim 4, wherein the luggage transits from following the moving object to moving along the route based on information received from the at least one sensor.

6. The smart luggage system of claim 5, wherein the luggage transits from moving along the route to following the object based on the information received from the at least one sensor.

7. The smart luggage system of claim 4, further comprising a camera configured to collect image information of a to-be-followed target;
wherein the luggage transits from following the moving object to moving along the route based on whether the to-be-followed target exists in the image information.

8. The smart luggage system of claim 5, further comprising a camera configured to collect image information of a to-be-followed target;
wherein the luggage transits from moving along the route to following the moving object based on whether the to-be-followed target exists in the image information.

9. The smart luggage system of claim 1, further comprising a camera configured to recognize gestures;
wherein when a gesture of hand pushing from chest of the gestures is recognized, the luggage changes from a moving state to a pause state.

10. The smart luggage system of claim 1, wherein the at least one sensor comprises an infrared sensor configured to detect downward obstacles or stairs.

11. The smart luggage system of claim 1, further comprising a camera;
wherein the camera is enabled after detecting the pull rod extracted from a collapsed position.

12. The smart luggage system of claim 1, wherein the smart luggage system shuts down after detecting the pull rod collapsed from an extracted position.

13. The smart luggage system of claim 1, further comprising a transceiver configured to receive commands from a wristband;
wherein when a press to a control button of the wristband is detected, the smart luggage system changes from a moving state to a pulling state.

14. The smart luggage system of claim 1, further comprising:
a transceiver configured to receive commands from a wristband; and
an indication light;
wherein when a press to a control button of the wristband is detected, the smart luggage system changes from a moving state to a pulling state and turns off the indication light.

15. The smart luggage system of claim 1, further comprising:
a transceiver configured to receive commands from a wristband; and
an indication light;
wherein when a pressing to a control button of the wristband for a period is detected, the smart luggage system makes the indication light blinking.

16. A smart luggage system, comprising:
a piece of luggage configured to store items for transport;
a pull rod coupled to the luggage;
at least one sensor coupled to the luggage and configured to detect an obstacle;
two driving wheels and two driven wheels coupled to the luggage, wherein the two driving wheels are motorized to move the luggage in a given direction; and
a main controller configured to determine a first route based on a map data, a beginning location, and a destination location;
wherein the pull rod and the at least one sensor are disposed on a front surface of the luggage;
wherein the two driven wheels are disposed near the front surface of the luggage and the two driving wheels are disposed near a rear surface of the luggage;
wherein the main controller is configured to guide the luggage to move along the first route.

17. The smart luggage system of claim 16, further comprising a USB port disposed on a top portion of the front surface of the luggage.

18. The smart luggage system of claim 16, wherein the at least one sensor is selected from at least one camera, infrared sensor or ultrasonic sensor.

19. The smart luggage system of claim 16, wherein the luggage transits from moving along the first route to following a moving object based on information received from the at least one sensor.

20. The smart luggage system of claim 16, further comprising a camera configured to collect image information of a to-be-followed target;
wherein the system transition from moving along the first route to following a moving object based on whether a to-be-followed target exists in image information.
